(19) United States
(12) Patent Application Publication
(10) Pub. No.: US 2021/0091857 A1
(43) Pub. Date: Mar. 25, 2021

(54) HYBRID SYSTEM WITH AOC AND AEC AND OPTICAL TRANSCEIVER SYSTEM THEREOF

(71) Applicant: James Cheng Lee, La Habra, CA (US)

(72) Inventor: James Cheng Lee, La Habra, CA (US)

(21) Appl. No.: 16/699,658

(22) Filed: Dec. 1, 2019

Related U.S. Application Data
(60) Provisional application No. 62/904,837, filed on Sep. 24, 2019.

(30) Foreign Application Priority Data
Oct. 21, 2019 (TW) 108137956

(51) Int. Cl. H04B 10/516; H04B 10/40; H04B 10/50; H04B 10/25

(52) U.S. Cl. CPC H04B 10/5161; H04B 10/2504; H04B 10/502; H04B 10/40

(57) ABSTRACT

An optical transceiver system includes a PAM4 conversion device, a light emitting device, a light receiving device and an interface unit. The light emitting device is coupled to the PAM4 conversion device and receives a first PAM4 signal from the PAM4 conversion device. The light receiving device is coupled to the PAM4 conversion device and transmits a second PAM4 signal to the PAM4 conversion device. The interface unit is coupled to the PAM4 conversion device through an active electrical cable device and transmits a first NRZ signal to the PAM4 conversion device. The first NRZ signal is converted into the first PAM4 signal by the PAM4 conversion device, and the second PAM4 signal is converted into a second NRZ signal by the PAM4 conversion device, and the second NRZ signal is transmitted to the interface unit.

### CROSS-REFERENCE TO RELATED APPLICATION

This application claims the priorities of US provisional patent application No. 62/904,837, filed on Sep. 24, 2019 and Taiwanese patent application No. 108137956, filed on Oct. 21, 2019, which are incorporated herewith by reference.

### BACKGROUND OF THE INVENTION

### 1. Field of the Invention

The present invention relates generally to a high-speed data transmission transceiver system, and more particularly, to a hybrid system with an active optical cable (AOC) and an active electrical cable (AEC) and an optical transceiver system thereof.

### 2. The Prior Arts

Non-return-to-zero modulation (NRZ modulation) is widely used in high-speed data transmission. The dense wavelength division multiplexing system and the planar lightwave circuit (PLC) technology are often used for conversion between a high-speed module and a low-speed module to implement the fan-out cable configuration for conversion from high-speed to low-speed.

4-level pulse amplitude modulation (PAM4 modulation) will make the transmission data of the system increase. However, in the conversion from high-speed to low-speed, communication problems of different modulation modes are generated, and cannot be solved by the dense wavelength division multiplexing system and the planar lightwave circuit technology.

In addition, a PAM4 photoelectric conversion is also required before performing the PAM4 and NRZ conversion, and then a NRZ photoelectric conversion is performed. However, such a method requires increasing the photoelectric conversion devices in power supply, thereby increasing the required power and the device cost.

Therefore, it is necessary to provide a modulation conversion method that can achieve the above communication requirements and reduce the cost and the power consumption.

### SUMMARY OF THE INVENTION

A primary objective of the present invention is to provide a hybrid system with an AOC and an AEC that can achieve the advantageous effects of low cost and low power consumption under different modulation and communication conditions.

An embodiment of the present invention is to provide an optical transceiver system, comprising: a PAM4 conversion device, a light emitting device, a light receiving device, and an interface unit. The light emitting device is coupled to the PAM4 conversion device for receiving a first PAM4 signal from the PAM4 conversion device. The light receiving device is coupled to the PAM4 conversion device for transmitting a second PAM4 signal to the PAM4 conversion device. The interface unit is coupled to the PAM4 conversion device through an active electrical cable device for transmitting a first NRZ signal to the PAM4 conversion device. The first NRZ signal is converted into the first PAM4 signal by the PAM4 conversion device, and the second PAM4 signal is converted into a second NRZ signal by the PAM4 conversion device, and the second NRZ signal is transmitted to the interface unit.

Another embodiment of the present invention is to provide a hybrid system with an AOC and an AEC, comprising an active optical cable device, a PAM4 conversion device, a light emitting device, a light receiving device, and an interface unit. The light emitting device is coupled to the PAM4 conversion device for receiving a first PAM4 signal from the PAM4 conversion device. The light receiving device is coupled to the PAM4 conversion device for transmitting a second PAM4 signal to the PAM4 conversion device. The interface unit is coupled to the PAM4 conversion device through an active electrical cable device for transmitting a first NRZ signal to the PAM4 conversion device. The first NRZ signal is converted into the first PAM4 signal by the PAM4 conversion device, and the second PAM4 signal is converted into a second NRZ signal by the PAM4 conversion device, and the second NRZ signal is transmitted to the interface unit.

The present invention provides the hybrid system with the AOC and the AEC and the optical transceiver system thereof that can achieve the above-mentioned communication requirements without additional photoelectric conversions before and after the general PAM4 and NRZ conversion, and thus does not need the additional photoelectric conversion devices. As a result, it can achieve the effect of reducing the required power and the device cost.

It will be understood by those skilled in the art that the effects of the present invention are not limited to the details described above, and the advantages of the present invention will be more clearly understood from the detailed description.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic diagram of a system according to an embodiment of the present invention; and

FIG. 2 is a block diagram of a system according to an embodiment of the present invention.

### DETAILED DESCRIPTION OF THE PREFERRED EMBODIMENT

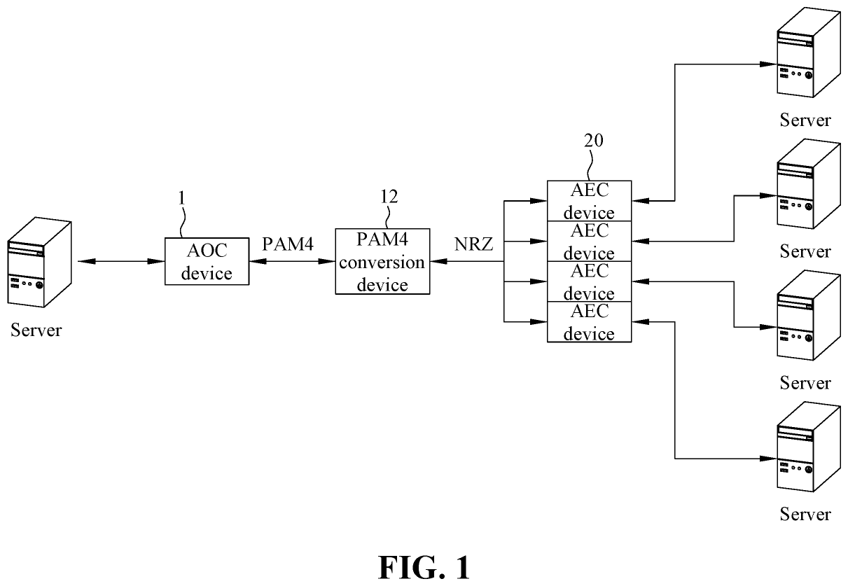

Referring to FIG. 1, FIG. 1 is a schematic diagram of a system according to an embodiment of the present invention. As shown in FIG. 1, an active optical cable (AOC) device 1 and an active electrical cable (AEC) device 20 are used for data transmission between servers, and the modulation conversion of the PAM4 and the NRZ is performed by a PAM4 conversion device 12. The PAM4 modulation mode can make the structure of the module simpler and be helpful to save the circuit cost.

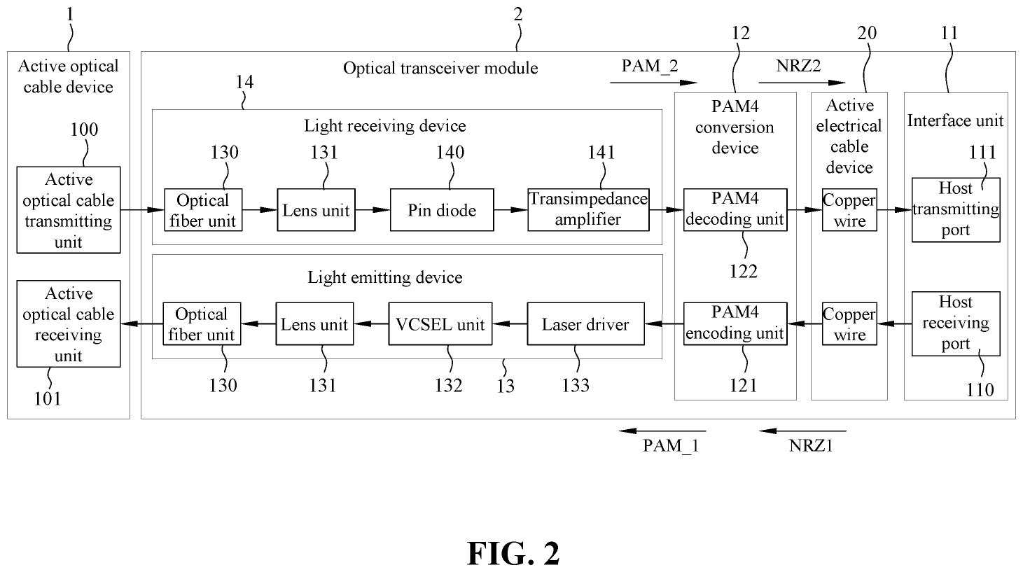

Please refer to FIG. 2. FIG. 2 is a block diagram of a system according to an embodiment of the present invention. The hybrid system with an AOC and an AEC in FIG. 2 includes the active optical cable device 1 and an optical transceiver module 2. The optical transceiver module 2 includes an interface unit 11, a PAM4 conversion device 12, a light emitting device 13, and a light receiving device 14.

The interface unit 11 is coupled to the PAM4 conversion device 12 through the active electrical cable device 20 and transmits a first NRZ signal NRZ1 to the PAM4 conversion device 12.

The PAM4 conversion device 12, which is coupled to the light emitting device 13 and the light receiving device 14, converts the first NRZ signal NRZ1 into a first PAM4 signal PAM 1, and transmits the first PAM4 signal PAM_1 to the light emitting device 13 to allow the light emitting device 13 to emit the first PAM4 signal PAM_1 in a laser signal pattern.

The PAM4 conversion device 12 receives a second PAM4 signal PAM_2 from the light receiving device 14, converts the second PAM4 signal PAM_2 into a second NRZ signal NRZ2, and transmits the second NRZ signal NRZ2 to the interface unit 11.

In this embodiment, the active optical cable device 1 includes an active optical cable transmitting unit 100 coupled to the light receiving device 14 and an active optical cable receiving unit 101 coupled to the light emitting device 13. The PAM4 conversion device 12 includes a PAM4 encoding unit 121 and a PAM4 decoding unit 122. The interface unit 11 includes a host receiving port 110 and a host transmitting port 111. The PAM4 encoding unit 121 is coupled to the host receiving port 110 for receiving and then converting the first NRZ signal NRZ1 into the first PAM4 signal PAM 1, so as to be output to the light emitting device 13.

The PAM4 decoding unit 122 decodes the received second PAM4 signal PAM_2 into a second NRZ signal NRZ2, and the second NRZ signal NRZ2 is output by the host transmitting port 111.

The PAM4 encoding unit 121 in the above embodiment may be specifically composed of a channel attachment unit interface (CAUI) receiving unit, a clock data recovery circuit, a signal multiplexer, a forward error correction coding unit, and a PAM4 encoder. The CAUI receiving unit acquires the first NRZ signal NRZ1 of the host receiving port 110. The clock data recovery circuit can recover the clock data of the first NRZ signal NRZ1, process it by the signal multiplexer and the forward error correction coding unit, and then transmit it to the PAM4 encoder for being converted into the first PAM4 signal PAM_1.

The PAM4 decoding unit 122 in the above embodiment may be specifically composed of an analog-to-digital converter, a digital signal processing unit, a signal demultiplexer, a forward error correction decoding unit, and a CAUI emitting unit. The analog-to-digital converter receives the second PAM4 signal PAM_2 transmitted from the light receiving device 14, and converts it into a digital signal for conversion by the digital signal processing unit, error correction decoding by the signal demultiplexer and the forward error correction decoding unit, and then being transmitted to the host transmitting port 111 through the CAUI emitting unit.

Additionally, in this embodiment, the active electrical cable device 20 is composed of copper wire. The light receiving device 14 includes an optical fiber unit 130, a lens unit 131, a pin diode 140, and a transimpedance amplifier 141. The light emitting device 13 includes the optical fiber unit 130, the lens unit 131, a vertical cavity surface-emitting laser (VCSEL) unit 132, and a laser driver 133.

The laser driver 133 receives a differential voltage signal corresponding to the first PAM4 signal PAM_1 from the PAM4 encoding unit 121 and converts it into a current driving signal to drive the VCSEL unit 132, and the VCSEL unit 132 emits an optical signal to an external optical network.

The pin diode 140 is configured to receive the optical signal transmitted from the external optical network and convert it into a weak current signal and transmit it to the transimpedance amplifier 141. The transimpedance amplifier 141 is configured to convert the current signal into the differential voltage signal corresponding to the second PAM4 signal PAM 2, and then be transmitted to the PAM4 decoding unit 122.

The hybrid system with the AOC and the AEC and the optical transceiver system thereof according to the present invention use the PAM4 modulation mode to make the structure of the optical module simpler, and the hybrid use of the active optical cable does not need to perform the additional photoelectric conversions before and after the general PAM4 and NRZ conversion, and thus does not need the additional photoelectric conversion devices. As a result, it can achieve the communication requirements and reduce the required power and the device cost.

It will be apparent to those skilled in the art that the present invention may be embodied in other specific forms without departing from the spirit of the present invention. Therefore, the above description should not be construed as limiting in all aspects, but rather as illustrative.

The scope of the present invention is to be determined by the scope of the appended claims, and all modifications within the scope of the present invention are included in the scope of the present invention.

1. An optical transceiver system, comprising:
a PAM4 conversion device;
a light emitting device coupled to the PAM4 conversion device for receiving a first PAM4 signal from the PAM4 conversion device;
a light receiving device coupled to the PAM4 conversion device for transmitting a second PAM4 signal to the PAM4 conversion device; and
an interface unit coupled to the PAM4 conversion device through an active electrical cable device for transmitting a first NRZ signal to the PAM4 conversion device,
wherein the first NRZ signal is converted into the first PAM4 signal by the PAM4 conversion device, and the second PAM4 signal is converted into a second NRZ signal by the PAM4 conversion device, and the second NRZ signal is transmitted to the interface unit.

2. The optical transceiver system according to claim 1, wherein the PAM4 conversion device includes a PAM4 encoding unit and a PAM4 decoding unit, and the interface unit includes a host receiving port and a host transmitting port, and the PAM4 encoding unit is coupled to the host receiving port for receiving and converting the first NRZ signal into the first PAM4 signal, so as to be output to the light emitting device, and the PAM4 decoding unit is coupled to the host transmitting port and is used for receiving and decoding the second PAM4 signal from the light receiving device into the second NRZ signal, so as to be output by the host transmitting port.

3. The optical transceiver system according to claim 1, wherein the active electrical cable device is composed of copper wire.

4. The optical transceiver system according to claim 1, wherein the light receiving device includes an optical fiber unit, a lens unit, a pin diode, and a transimpedance amplifier.

5. The optical transceiver system according to claim 1, wherein the light emitting device includes an optical fiber unit, a lens unit, a vertical cavity surface-emitting laser (VCSEL) unit, and a laser driver.

6. A hybrid system with an active optical cable (AOC) and an active electrical cable (AEC), comprising:
an active optical cable device;
a PAM4 conversion device coupled to the active optical cable device;
a light emitting device coupled to the PAM4 conversion device for receiving a first PAM4 signal from the PAM4 conversion device;
a light receiving device coupled to the PAM4 conversion device for transmitting a second PAM4 signal to the PAM4 conversion device; and
an interface unit coupled to the PAM4 conversion device through an active electrical cable device for transmitting a first NRZ signal to the PAM4 conversion device;
wherein the first NRZ signal is converted into the first PAM4 signal by the PAM4 conversion device, and the second PAM4 signal is converted into a second NRZ signal by the PAM4 conversion device, and the second NRZ signal is transmitted to the interface unit.

7. The hybrid system according to claim 6, wherein the active optical cable device includes an active optical cable transmitting unit and an active optical cable receiving unit coupled to the light emitting device, and the PAM4 conversion device includes a PAM4 encoding unit and a PAM4 decoding unit, and the interface unit includes a host receiving port and a host transmitting port, and the PAM4 encoding unit is coupled to the host receiving port for receiving and converting the first NRZ signal into the first PAM4 signal, so as to be output to the light emitting device, and the PAM4 decoding unit is coupled to the host transmitting port and is used for receiving and decoding the second PAM4 signal from the light receiving device into the second NRZ signal, so as to be output by the host transmitting port.

8. The hybrid system according to claim 6, wherein the active electrical cable device is composed of copper wire.

9. The hybrid system according to claim 6, wherein the light receiving device includes an optical fiber unit, a lens unit, a pin diode, and a transimpedance amplifier.

10. The hybrid system according to claim 6, wherein the light emitting device includes an optical fiber unit, a lens unit, a vertical cavity surface-emitting laser (VCSEL) unit, and a laser driver.
